(19) United States
(12) Patent Application Publication
(10) Pub. No.: US 2007/0132787 A1
(43) Pub. Date: Jun. 14, 2007

(54) Multimedia system having application scaling function, application scaling method, and recording medium storing program for performing the method

(75) Inventor: Hye-kyung Ko, Incheon (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/525,987

(22) Filed: Sep. 25, 2006

(30) Foreign Application Priority Data
Dec. 6, 2005 (KR) 10-2005-0118017

(51) Int. Cl. G09G 5/00

(52) U.S. Cl. 345/660; 345/698

(57) ABSTRACT

A multimedia system that automatically scales an application according to the resolution of a graphics device when applications having different resolutions coexist on one screen, a method of scaling an application, and a recording medium storing a program for performing the method. The method includes setting a ratio of a reference resolution included in information regarding an application loaded to the multimedia system to a resolution of a graphics device of the multimedia system as a first scaling value; and scaling the application based on the first scaling value and displaying the application.

### CROSS-REFERENCE TO RELATED PATENT APPLICATION

This application claims priority from Korean Patent Application No. 10-2005-0118017, filed on Dec. 6, 2005, in the Korean Intellectual Property Office, the disclosure of which is incorporated herein in its entirety by reference.

### BACKGROUND OF THE INVENTION

1. Field of the Invention

Systems and methods consistent with the present invention relate to a multimedia system in which a plurality of applications can coexist, and more particularly, to a multimedia system which is capable of scaling a plurality of applications having different resolutions to work with the resolution of the system, a method of scaling an application, and a recording medium storing a program for performing the method.

2. Description of the Related Art

A multimedia system in which a plurality of applications having different resolutions can coexist includes a multimedia receiver such as a digital television or a digital multimedia broadcasting (DMB) receiver for receiving data broadcasting and a multimedia player such as a blue-ray disc player.

Middleware of a multimedia system, as shown in FIG. 1, includes a graphics device (or graphics plane), a video device (or video plane), and a background device (or background plane).

A graphics device outputs a broadcasting application received by the multimedia system, or an application residing in a multimedia system. The application may be an application operating independently of audio-video (AV) data, such as a weather report, a stock price, a menu, or a game, or an application related to AV data, such as drama information.

A video device outputs AV data. A background device outputs a background image or a background color. The background image is displayed as the output of the background device when no image is output from the video device or an output image is resized.

A multimedia system combines outputs of the graphics device, the video device and the background device and displays the result on a screen.

However, an application may be displayed off of a screen, or at a different position than where it is intended to be displayed when the resolution of the graphics device provided to the multimedia system is different from the resolution of the application being executed.

An application is displayed off of the screen when the resolution of the application is higher than the resolution of the graphics device. An application is displayed at a different position than where it is intended to be displayed when the resolution of the application is lower than the resolution of the graphics device.

FIGS. 2A, 2B, and 2C are examples of a screen when the resolution of an application is different from the resolution of a graphics device. Referring to FIGS. 2A, 2B, and 2C, if the application to be executed has a function of resizing an image to the size of a full screen with a low resolution, as shown in FIG. 2A, the resolution of the graphics device of the multimedia system is high. A full screen image shown in FIG. 2B is resized when the application is executed, as shown in FIG. 2C. The full screen image fails to fill the full screen and may be displayed (the screen does not move) in the upper left-hand corner of the screen, as shown in FIG. 2C.

To solve this problem, an application programming interface (API) call for converting the resolution of a graphics device into a desired resolution when executing an application has been proposed.

However, when using the API call, if applications having each other different resolutions coexist on one screen, when the resolution of the graphics device of one application is converted into the desired resolution, other applications with different resolutions are displayed outside of the screen, or displayed too small in the corner of the screen as shown in FIG. 2C.

### SUMMARY OF THE INVENTION

The present invention provides a multimedia system that automatically scales an application according to the resolution of a graphics device when a plurality of applications with different resolutions coexist on one screen, a method of scaling an application, and a recording medium storing a program for performing the method.

According to an aspect of the present invention, there is provided a method of scaling an application in a multimedia system, the method including: setting a ratio of a reference resolution included in information regarding an application loaded to the multimedia system to a resolution of a graphics device of the multimedia system as a first scaling value; and scaling the application based on the first scaling value and displaying the scaled application.

The method may further include: determining whether the resolution of the application is equal to a resolution supported by the graphics device when the reference resolution is not included in the information regarding the loaded application; detecting a resolution supported by the graphic device closest to the resolution of the application when the resolution of the application is not equal to a resolution supported by the graphics device; setting a ratio of the detected closest resolution to the current resolution of the graphics device as a second scaling value; and scaling the application based on the second scaling value and displaying the scaled application.

According to another aspect of the present invention, there is provided a multimedia system including: a graphics device; an application loaded to the multimedia system: an execution unit executing the application based on information regarding the application; a detection unit detecting a reference resolution from the information regarding the application when receiving notification of execution of the application from the execution unit; a scaling unit calculating a ratio of the reference resolution to the resolution of the graphics device, setting the calculated ratio as a first scaling value, and scaling the application based on the first scaling value; and a display unit displaying the application scaled by the scaling unit.

The scaling unit may set the ratio of a resolution supported by the graphics device closest to the resolution of the application to the current resolution of the graphics device as a second scaling value, and scales the application using the second scaling value when the detection unit does not detect the reference resolution.

According to another aspect of the present invention, there is provided a computer-readable recording medium storing a program for performing a method of scaling an application in a multimedia system, the method including: setting the ratio of a reference resolution included in information regarding an application loaded in the multimedia system to the resolution of a graphics device as a first scaling value; and scaling the application based on the first scaling value and displaying the application.

In the computer-readable recording medium, the method may further include: determining whether the resolution of the application is equal to a resolution supported by the graphics device when the reference resolution is not included in the information regarding the loaded application; detecting a resolution supported by the graphic device closest to the resolution of the application when the resolution of the application is not equal to a resolution supported by the graphics device; setting a ratio of the detected resolution to the current resolution of the graphics device as a second scaling value; and scaling the application based on the second scaling value and displaying the application.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a configuration of middleware of a related art multimedia system;

FIG. 2A is an image of a screen displaying an application;

FIG. 2B is an image of a screen displaying a full-sized video;

FIG. 2C an image of a screen displaying a resized video when executing an application;

FIG. 3 is a functional block diagram of a multimedia system according to an exemplary embodiment of the present invention;

FIG. 4 is an image of a screen displaying an application that is scaled according to an exemplary embodiment of the present invention;

FIG. 5 is a functional block diagram of a multimedia system according to another exemplary embodiment of the present invention;

FIG. 6 is a detailed block diagram of a scaling unit shown in FIG. 5;

FIG. 7 is a functional block diagram of a multimedia system according to another exemplary embodiment of the present invention;

FIG. 8 is a functional block diagram of a multimedia system according to another exemplary embodiment of the present invention;

FIG. 9 is a flowchart illustrating a method of scaling an application according to an exemplary embodiment of the present invention;

FIG. 10 is a flowchart illustrating a method of scaling an application according to another exemplary embodiment of the present invention; and

FIG. 11 is a flowchart illustrating a method of scaling an application according to another exemplary embodiment of the present invention.

### DETAILED DESCRIPTION OF EXEMPLARY EMBODIMENT OF THE INVENTION

Exemplary embodiments of the present invention will now be described more fully with reference to the accompanying drawings.

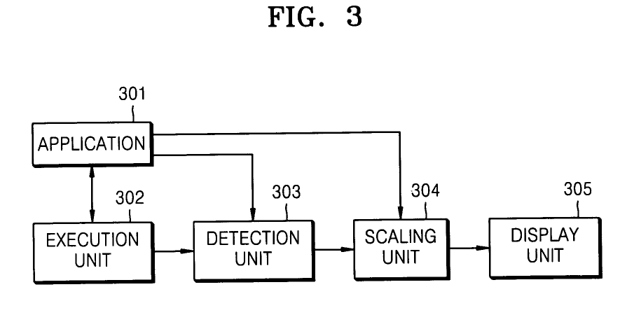

FIG. 3 is a functional block diagram of a multimedia system according to an exemplary embodiment of the present invention. Referring to FIG. 3, the multimedia system includes an application 301, an execution unit 302, a detection unit 303, a scaling unit 304, and a display unit 305.

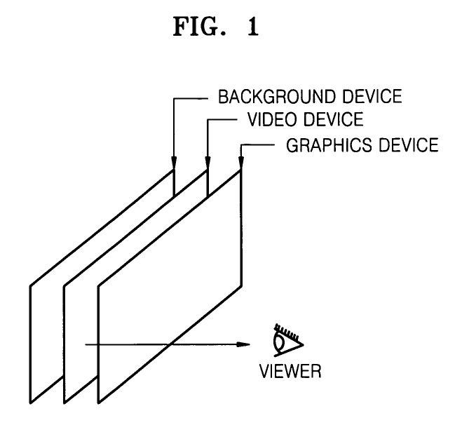

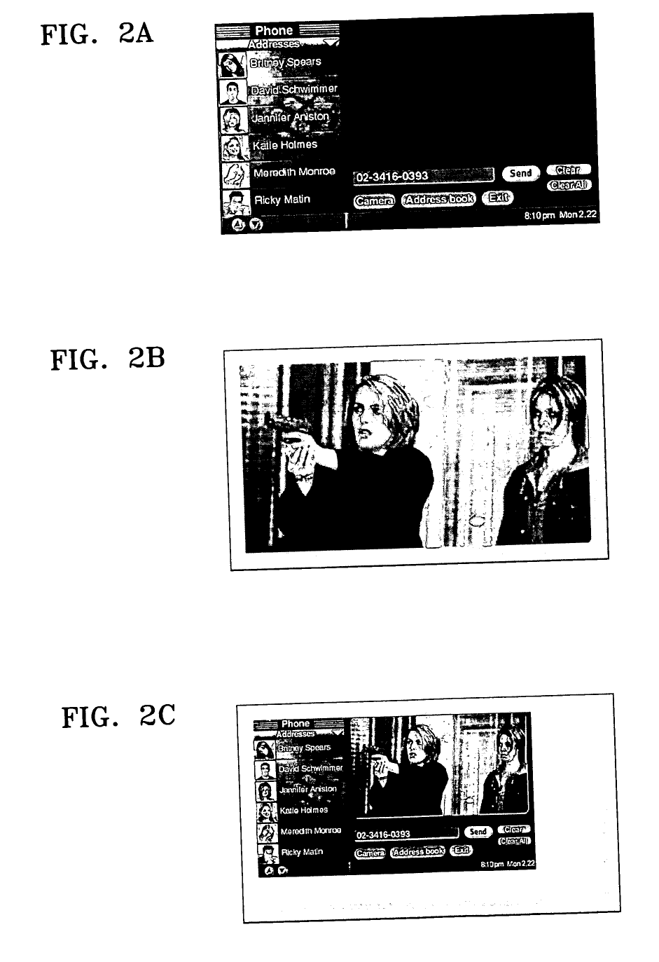

The application 301, which is loaded to the multimedia system, is included in a broadcasting application received by the multimedia system or is pre-stored in the multimedia system, as described above with reference to FIG. 1. The application 301 may be an application to be executed independently of AV data, such as a weather report, stock prices, a menu, or a game, or an application related to AV image, such as drama information.

The application 301 provides information regarding the application 301 to the execution unit 302 and the detection unit 303 in the form of an API call or separate data. The information regarding the application 301 provided to the execution unit 302 includes information regarding whether the application 301 runs, such as ‘auto start’, and the information regarding the application 301 provided to the detection unit 303 includes a reference resolution. The reference resolution is set by a developer based on the full size of a screen of a graphics device of a multimedia system related to the application 301. For example, the developer can set the reference resolution of the application to 600×400 when the resolution of the graphics device of the multimedia system is 640×480 (width×height). In this case, the reference resolution of the application 301 is set to 640×480.

The execution unit 302 runs the application 301 based on the information regarding the application 301 provided by the application 301. More specifically, the execution unit 302 automatically executes the application 301 when the information regarding the execution of the application 301 indicates ‘auto start’. Conversely, the executing 302 does not automatically execute the application 301 when the information regarding the execution of the application 301 does not indicate ‘auto start’.

The detection unit 303 detects the reference resolution from the information regarding the application 301 provided by the application 301 when receiving notification of execution of the application 301 from the execution unit 302.

The scaling unit 304 calculates the ratio of the resolution of the graphics device (not shown) to the reference resolution provided by the detection unit 303, sets the calculated ratio as a first scaling value, and scales the application 301. The resolution of the graphic devices (not shown) is pre-set. The scaling unit 304 obtains the ratio by dividing the resolution of the graphics device by the reference resolution.

The scaling unit 304 multiplies coordinates values of components of the application 301 by the first value to obtain new coordinates values. The scaling unit then outputs an application with the obtained new coordinate values as the scaled application. The scaled application output from the scaling unit 304 is provided to the display unit 305.

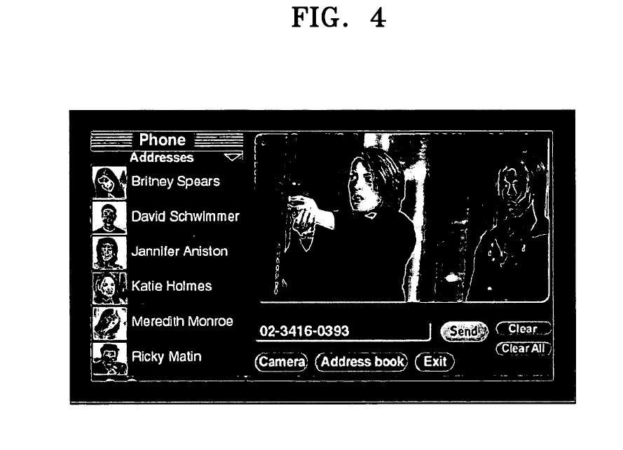

The display unit 305 includes a graphics device (not shown), a video device (not shown), and a background device (not shown), which are arranged as shown in FIG. 1, a control unit (not shown) controlling the graphics device, the video device, and the background device, and an image output unit (not shown). The image output unit combines images output from the graphics device, the video device, and the background device into one image. The scaled application input from the scaling unit 304 is output to the image output unit through the graphics device of the display unit 305. The scaled application and the video image are accordingly displayed as shown in FIG. 4. FIG. 4 is an image of a screen displaying the application scaled based on the resolution of the graphics device included in the display unit 305. The video image may be an image resized through a process of resizing an image, which will be described later.

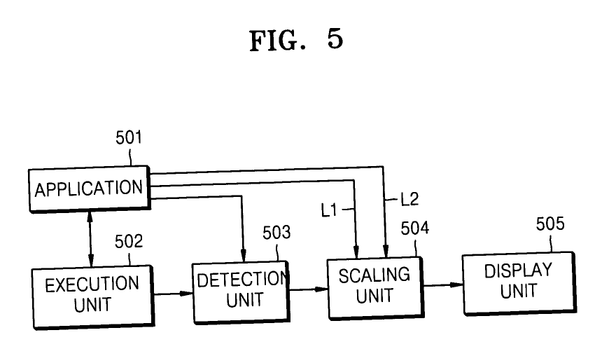

FIG. 5 is a functional block diagram of a multimedia system according to another exemplary embodiment of the present invention. Referring to FIG. 5, the multimedia system includes an application 501, an execution unit 502, a detection unit 503, a scaling unit 504, and a display unit 505.

In the exemplary embodiment shown in FIG. 5, reference resolution of the application 501 is not detected from the information regarding the application in the exemplary embodiment shown in FIG. 3.

That is, the application 501, the execution unit 502, and the display unit 505 shown in FIG. 5 are similar to the application 301, the execution unit 302, and the display unit 305 in terms of their operations and configuration.

The detection unit 503 detects the reference resolution from the information regarding the application when receiving notification of execution of the application from the execution unit 502. The detection unit 503 transmits a failure notification to the scaling unit 504 when the reference resolution of the application 501 is not detected from the information regarding the application 501.

The scaling unit 504 performs scaling in the same manner as described above with reference to FIG. 3 when receiving the reference resolution from the detection unit 503. However, the scaling unit 504 detects the resolution that can be supported by the graphic device included in the display unit 505 closest to the resolution of the application 501 when receiving the notification that the reference resolution is not detected from the detection unit 503. The resolution of the application 501 is based on the window size of the application 501 provided in the form of API call of the application 501 through a signal line L1.

The scaling unit 504 then calculates the ratio of the detected resolution supported by the graphics device to the current resolution of the graphic device. The scaling unit 504 sets the calculated ratio as a second scaling value. The scaling unit 504 converts coordinates of each component of the application 501 transmitted through a signal line L2 into new coordinates and scales the application 501. The method of calculating the ratio and the method of scaling the application 501 based on the second scaling value are similar to the method of calculating the ratio and the method of scaling based on the first scaling value as described with reference to FIG. 3 above.

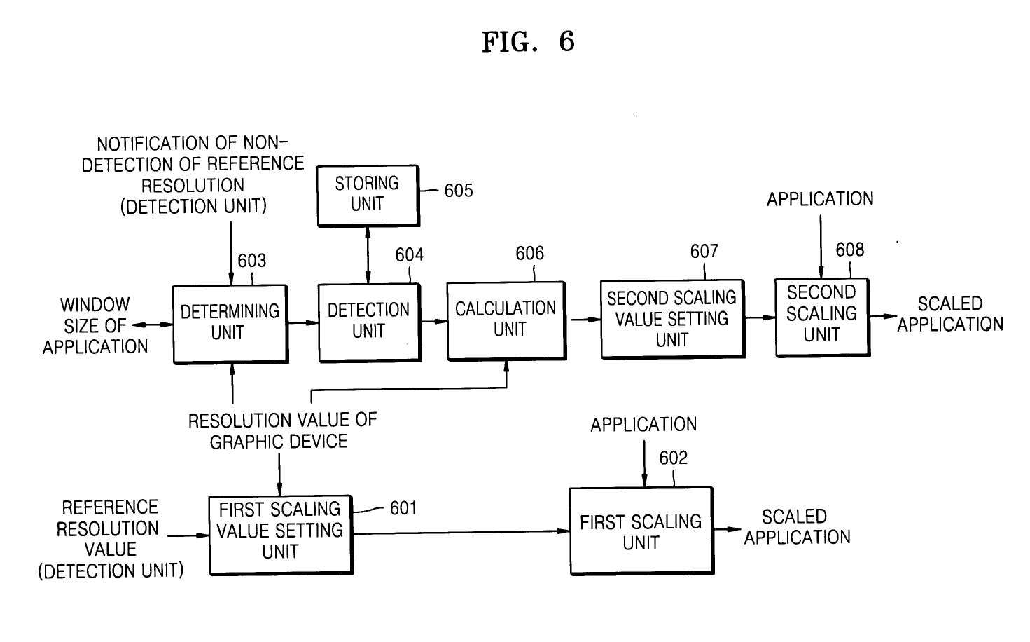

FIG. 6 is a detailed block diagram of the scaling unit 504. Referring to FIG. 6, the scaling unit 504 includes a first scaling value setting unit 601, a first scaling unit 602, a determining unit 603, a detection unit 604, a storing unit 605, a calculation unit 606, a second scaling value setting unit 607, and a second scaling unit 608.

The first scaling value setting unit 601 calculates the ratio of the reference resolution of the application 501 to the resolution of the graphics device included in the display 505 when receiving the reference resolution of the application 501 from the detection unit 503, and sets the calculated ratio as a first scaling value. The first scaling value setting unit 601 provides the first scaling value to the first scaling unit 602.

The first scaling unit 602 multiplies coordinate values of components of the application 501 input through the signal line L2 by the first scaling value to obtain new coordinate values. The first scaling unit 602 outputs the application with the new coordinate values as the scaled application. The output scaled application is transmitted to the graphics device included in the display unit 505. The graphics device outputs the application scaled based on the first scaling value.

The determining unit 603 determines whether the reference resolution of the application is different than the current resolution of the graphics device based on the window size of the application 501 when receiving notification (non detection) that the reference resolution is not detected and receiving the window size of the application 501 through the line L1.

More specifically, the determining unit 603 determines that the resolution of the application 501 is not equal to the current resolution of the graphics device in the display unit 505 when the value obtained by adding the window size to a starting position of window is greater than the current resolution of the graphics device. The window size of the application 501 is provided by the API call of the application.

The detection unit 604 detects the resolution closest to the resolution of the application 501 from the information stored in the storing unit 605 when receiving notification that the resolution of the application 501 is not equal to the resolutions supported by the graphics device. More specifically, the detection unit 604 detects the resolution supported by the graphics device that has a width and a height close to the width and height of the resolution to of the application 501.

The storing unit 605 stores a plurality of resolutions that are supported by the graphics device.

The calculating device 606 calculates the ratio of the resolution closest to the resolution of the application 501 provided by the detection unit 604 to the current resolution of the graphics device. The method of calculating the ratio is similar to the method of calculating the ratio as described with reference to FIG. 3 above.

The second scaling value setting unit 607 sets the ratio provided from the calculation unit 606 as the second scaling value.

The second scaling unit 608 converts the coordinate values of components of the application 501 provided through the signal line L2 into the new coordinate values based on the second scaling value provided from the second scaling value setting unit 607. The second scaling unit 608 accordingly outputs the scaled application with the new coordinate values.

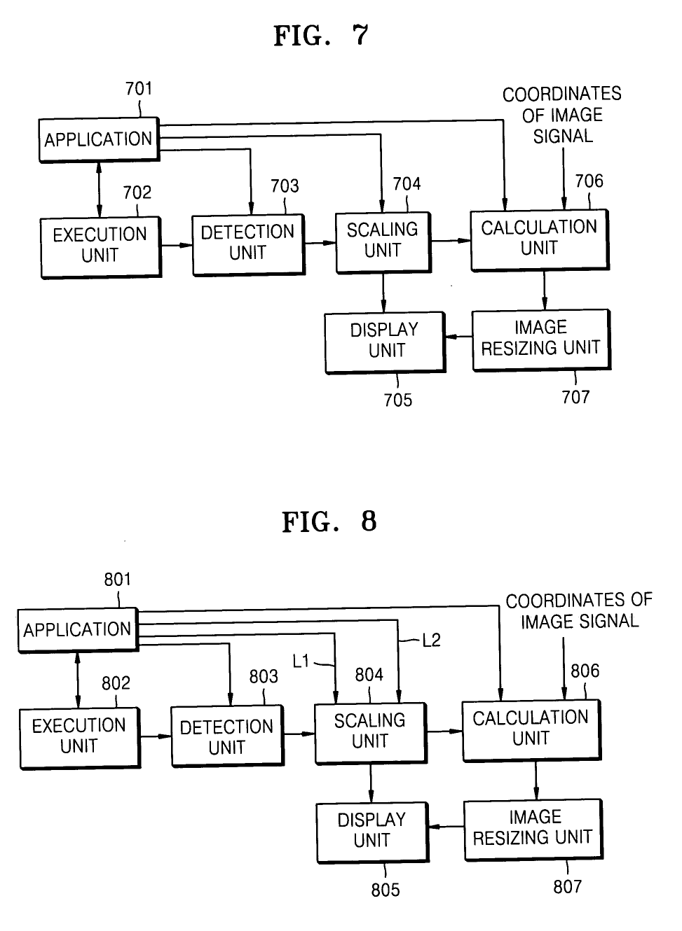

FIG. 7 is a functional block diagram of a multimedia system according to another exemplary embodiment of the present invention. Referring to FIG. 7, the multimedia system includes an application 701, an execution unit 702, a detection unit 703, a scaling unit 704, a display unit 705, a calculation unit 706, and an image resizing unit 707.

The multimedia system illustrated in FIG. 7 provides the same functions as the multimedia system illustrated in FIG. 3, and further provides a function of resizing an image to be displayed in response to a request for resizing the application.

In detail, the application 701, the execution unit 702, the detection unit 703, the scaling unit 704, and the display unit 705 in FIG. 7 are similar to the application 301, the execution unit 302, the detection unit 303, the scaling unit 304 and the display unit 305 in FIG. 3, in terms of operation and configuration.

The position of resizing of the image output from the video device of the display unit 705 is recalculated based on the first scaling value provided from the scaling unit 704 when the API call of the application requests for a resizing image after the scaled application is output to the display unit 705. The calculation to obtain position of resizing of the image is as described above with reference to FIG. 3.

More specifically, the position of resizing of the image is obtained by multiplying the first scaling value by a coordinate value of a pixel of the image output through the video device.

The image resizing unit 707 resizes the image to be output to the display unit 705 through the video device based on the resized position of the image provided from the calculation unit 706. The image is accordingly resized to correspond to the scaled application to be displayed on the display unit 705, thereby displaying the image as shown in FIG. 4.

FIG. 8 is a functional block diagram of a multimedia system according to another exemplary embodiment of the present invention. Referring to FIG. 8, the multimedia system includes an application 801, an execution unit 802, a detection unit 803, a scaling unit 804, a display unit 805, a calculation unit 806, and an image resizing unit 807.

The multimedia system illustrated in FIG. 8 provides the same functions as the multimedia system illustrated in FIG. 5, and further provides a function of resizing an image to be displayed in response to a request for resizing by the application after displaying the scaled application.

In detail, the application 801, the execution unit 802, the detection unit 803, the scaling unit 804, and the display unit 805 shown in FIG. 8 are similar to the application 501, the execution unit 502, the detection unit 503, the scaling unit 504 and the display unit 505, respectively, shown in FIG. 5 in terms of operation and configuration.

The calculation unit 806 calculates resizing position of the image based on one of a first scaling value and a second scaling value output from the scaling unit 804 when an API call of the application requests for the image resizing. The scaling unit 804 outputs the first scaling value when the detection unit 803 detects a reference resolution, and outputs the second scaling value when the detection unit 803 does not detect the reference resolution. Accordingly, the calculation unit 806 calculates the updated position of the image using the first scaling value when the detection unit 803 detects the reference resolution and calculates the resizing position of the image using the second scaling value when the detection unit 803 does not detect the reference resolution.

The image resizing unit 807 is similar to the image resizing unit 707 shown in FIG. 7 in terms of configuration and operation.

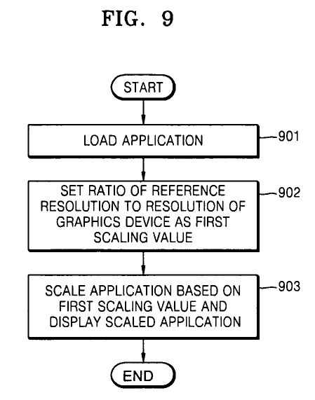

FIG. 9 is a flowchart illustrating a method of scaling an application according to an exemplary embodiment of the present invention.

Referring to FIG. 9, a ratio of a reference resolution of an application to a resolution of a graphics device (902) is set as a first scaling value when an application is loaded to the multimedia system (901). The loaded application is the same as described with reference to FIG. 3. Accordingly, the loaded application may be an application pre-stored in the multimedia system or may be a received application. The graphics device is provided to the multimedia system in the same arrangement as shown in FIG. 1.

The application is scaled based on the first scaling value, and is output through the graphics device of the multimedia system to be displayed (903).

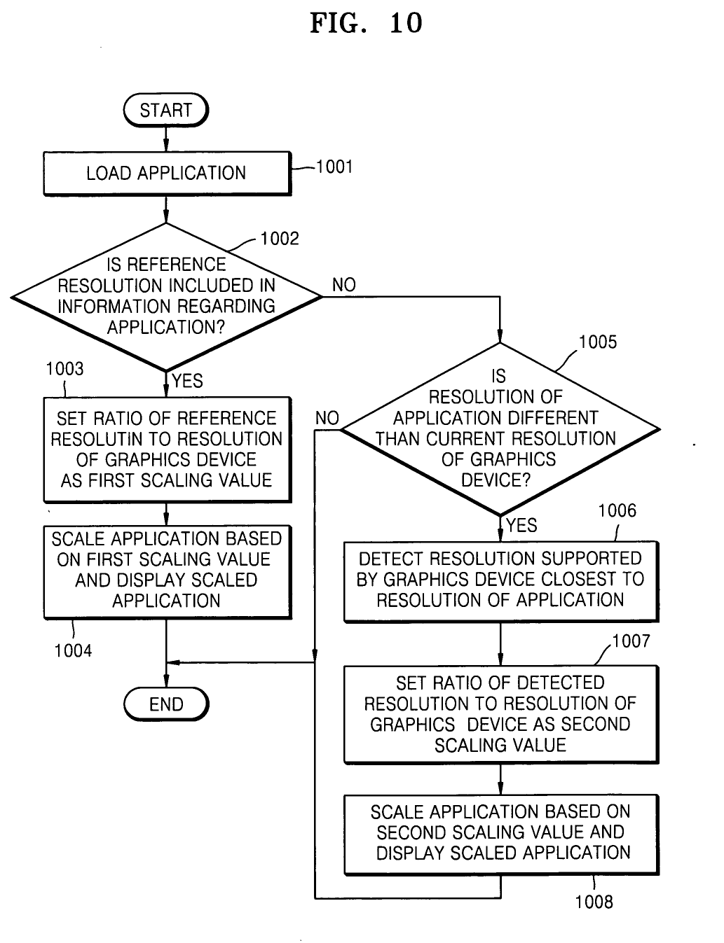

FIG. 10 is a flowchart illustrating a method of scaling an application according to another exemplary embodiment of the present invention. The method illustrated in FIG. 9 is an example in which a reference resolution value is included in information regarding the application. However, in the method illustrated in FIG. 10, a reference resolution may or may not be included in the information regarding the application.

Here, operations 1001, 1003, and 1004 of FIG. 10 are similar to operations 901, 902, and 903, respectively, of FIG. 9.

According to the method, it is determined whether the resolution of the application is different than the current resolution of a graphics device (1005) after it is determined that the reference resolution of the application is not included in the information regarding the application (1002). This determining operation is performed based on the window size of the application, as performed by the determining unit 603 shown FIG. 6.

If it is determined that the resolution of the application is different than the current resolution of the graphics device, the resolution supported by the graphics device that is closest to the resolution of the application is detected (1006). The operation of detecting the resolution closest to the resolution of the application is performed as described above with reference to the detection unit 604 of FIG. 6. Scaling of the application is terminated when the resolution of the application is equal to the resolution of the graphics device (1005).

A ratio of the detected resolution to the current resolution of the graphics device is calculated and set as a second scaling value (1007). The ratio is obtained as described above with reference to FIG. 3.

The method scales the application based on the second scaling value and displays the scaled application (1008).

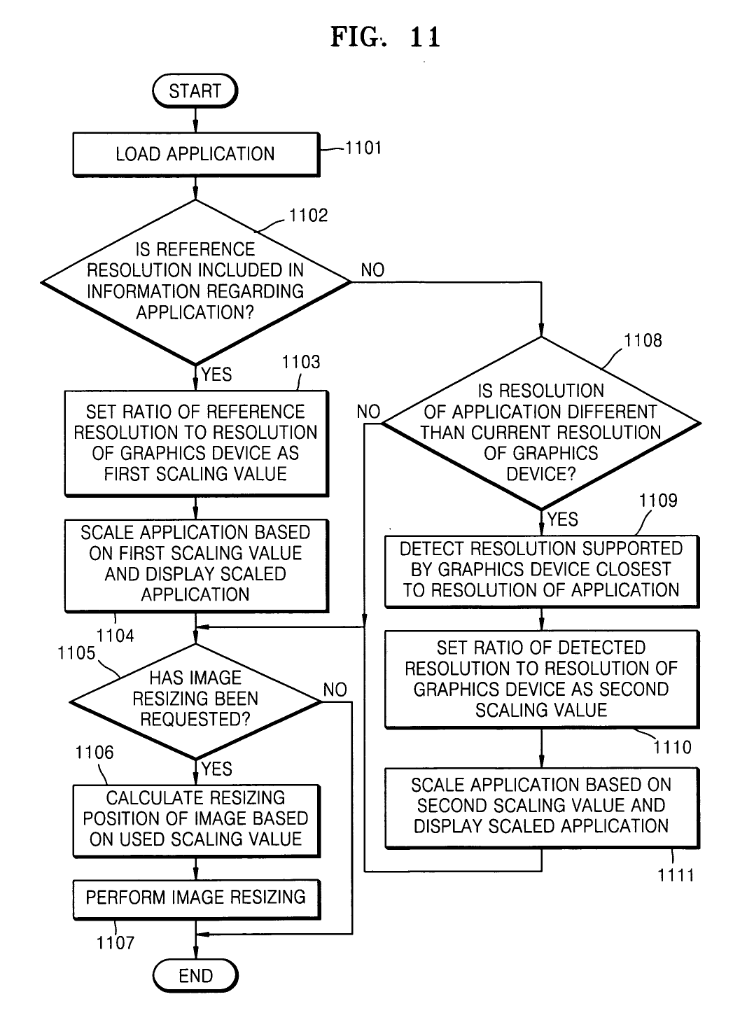

FIG. 11 is a flowchart illustrating a method of scaling an application according to another exemplary embodiment of the present invention. The method illustrated in FIG. 11 is similar to the method illustrated in FIG. 10, but further includes a function of resizing an image in response to the request of an API call of the application after scaling the application.

Here, operations 1101, 1102, 1103, 1104, 1108, 1109, 1110, and 1111 of FIG. 11 are identical to operations 1001, 1002, 1003, 1004 1005, 1006, 1007, and 1008 of FIG. 10, respectively.

The resizing position of the image is calculated based on one of the first scaling value and the second scaling value (1106) when an API call of the application requests image resizing (1105) after the application is scaled. The resizing position of the image is calculated as described above with reference to the calculation unit 706 of FIG. 7.

The image resizing is performed according to the resizing position of the image after resizing position of the image is calculated (1107). Accordingly, the image corresponding to the application to be output though the graphics device is resized and output. The image is output through the video device.

Operations 1105, 1106, and 1107 of FIG. 11 may be appended to operation 903 of FIG. 9 in another exemplary embodiment of the present invention.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed over network coupled computer systems so that the computer readable code is stored and executed in a distributed fashion.

According to the exemplary embodiments of the present invention, an application is automatically scaled when a plurality of applications having different resolutions coexist on one screen. Thus, problems that arise from a difference between a reference resolution that is set when an application is designed and a resolution of a graphics device of a multimedia system can be overcome. Furthermore, a plurality of applications having different resolutions are prevented from confusing a user.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of scaling an application in a multimedia system, the method comprising:
setting a ratio of a reference resolution included in information regarding an application loaded to the multimedia system to a resolution of a graphics device of the multimedia system as a first scaling value;
scaling the application based on the first scaling value; and
displaying the application scaled based on the first scaling value.

2. The method of claim 1, further comprising:
determining whether a resolution of the application is equal to a resolution supported by the graphics device if the reference resolution is not included in the information regarding the loaded application;
detecting a resolution supported by the graphic device closest to the resolution of the application if the resolution of the application is not equal to a resolution supported by the graphics device.
setting a ratio of the detected closest resolution to the resolution of the graphics device as a second scaling value;
scaling the application based on the second scaling value; and
displaying the application scaled based on the second scaling value.

3. The method of claim 2, wherein the determining whether the resolution of the application is equal to a resolution supported by the graphics device is performed based on a window size of the application.

4. The method of claim 3, further comprising:
calculating a resizing position of an image based on one of the first scaling value and the second scaling value in response to a request for image resizing by the application after scaling the application; and
performing the image resizing using the resizing position.

5. The method of claim 2, further comprising;
calculating a resizing position of an image based on one of the first scaling value and the second scaling value in response to a request for image resizing by the application after scaling the application; and
performing the image resizing using the resizing position.

6. The method of claim 1, further comprising:
calculating a resizing position of an image based on the first scaling value in response to a request for image resizing by the application after scaling the application; and
performing the image resizing using the resizing position.

7. A multimedia system comprising:
a graphics device;
an application loaded to the multimedia system:
an execution unit which executes the application based on information regarding the application;
a detection unit which detects a reference resolution from the information regarding the application if a notification of execution of the application is received from the execution unit;
a scaling unit which calculates a ratio of the reference resolution to a resolution of the graphics device, sets the calculated ratio as a first scaling value, and scales the application based on the first scaling value; and
a display unit which displays the application scaled based on the first scaling value by the scaling unit.

8. The multimedia system of claim 7, wherein the scaling unit sets a ratio of a resolution supported by the graphics device closest to the resolution of the application to the resolution of the graphics device as a second scaling value, and scales the application using the second scaling value if the detection unit does not detect the reference resolution.

9. The multimedia system of claim 7, wherein the scaling unit comprises:
a determining unit which determines whether the resolution of the application is equal to one of the resolutions supported by the graphics device if the detection unit does not detect the reference resolution;
a detection unit which detects a resolution supported by the graphics device that is closest to the resolution of the application if the determining unit determines that the resolution of the application is not equal to one of the resolutions supported by the graphic device;
a calculation unit which calculates the ratio of the detected resolution to the resolution of the graphics device;
a second scaling value which sets unit setting the ratio calculated by the calculation unit as a second scaling value; and
a second scaling unit which scales the application based on the second scaling value.

10. The multimedia system of claim 9, wherein the determining unit is operated based on a widow size provided by the application.

11. The multimedia system of claim 10, further comprising:
a calculation unit which calculates a resizing position of an image based on one of the first scaling value and the second scaling value in response to a request for image resizing by the application; and
an image resizing unit which resizes an image to display the scaled application on the display unit based on the resizing position.

12. The multimedia system of claim 9, further comprising:
a calculation unit which calculates a resizing position of an image based on one of the first scaling value and the second scaling value in response to a request for image resizing by the application; and
an image resizing unit which resizes an image to display the scaled application on the display unit based on the resizing position.

13. The multimedia system of claim 8, further comprising:
a calculation unit which calculates a resizing position of an image based on one of the first scaling value and the second scaling value in response to a request for image resizing by the application; and
an image resizing unit which resizes an image to display the scaled application on the display unit based on the resizing position.

14. The multimedia system of claim 7, further comprising:
a calculation unit which calculates a resizing position of an image based on the first scaling value in response to a request for image resizing by the application; and
an image resizing unit which resizes an image to display the scaled application on the display unit based on the resizing position.

15. A computer-readable recording medium storing a program for performing a method of scaling an application in a multimedia system, the method comprising:
setting a ratio of a reference resolution included in information regarding an application loaded in the multimedia system to a resolution of a graphics device as a first scaling value;
scaling the application based on the first scaling value; and
displaying the application scaled based on the first scaling value.

16. The computer-readable recording medium of claim 15, the method further comprising:
determining whether a resolution of the application is equal to a resolution supported by the graphics device if the reference resolution is not included in the information regarding the loaded application;
detecting a resolution supported by the graphic device closest to the resolution of the application if the resolution of the application is not equal to a resolution supported by the graphics device;
setting a ratio of the detected closest resolution to the resolution of the graphics device as a second scaling value; and
scaling the application based on the second scaling value and displaying the application scaled based on the second scaling value.
